(19) United States
(12) Patent Application Publication
(10) Pub. No.: US 2005/0278181 A1
(43) Pub. Date: Dec. 15, 2005

(54) Method of analyzing corporate disclosures

(75) Inventor: Philip R. Houston, Williamsburg, VA (US)

Correspondence Address: FISH & NEAVE IP GROUP;ROPES & GRAY LLP, ONE INTERNATIONAL PLACE, BOSTON, MA, 02110-2624, US

(73) Assignee: Business Intelligence Advisors, Inc, Boston, MA (US)

(21) Appl. No.: 10/773,046

(22) Filed: Feb. 5, 2004

Related U.S. Application Data
(60) Provisional application No. 60/445,395, filed on Feb. 6, 2003.

(51) Int. Cl. G06F 17/60

(52) U.S. Cl. 705/1

(57) ABSTRACT

The present invention provides a method for identifying potentially deceptive statements in a corporate disclosure. Declaration portions or interview portions, or both, of a disclosure given by a corporate representative are reviewed to determine whether a cluster of deceptive behaviors is exhibited in response to stimuli. A declaration is typically a series of statements intended to set out a position or viewpoint that the representative would like to make known. During a declaration, a stimulus might be the beginning of the declaration, a change in topics or the beginning of a statement. During an interview, a stimulus will typically be a question posed by an interviewer.

### CLAIM TO EARLIER FILED RELATED PATENT APPLICATION

This Application claims priority to an earlier filed patent application Ser. No. 06/445,395, filed Feb. 6, 2003, the contents of which are hereby incorporated by reference.

### BACKGROUND

The systems and methods described herein relate to methods for analyzing the veracity and completeness of corporate disclosures. In certain embodiments, the methods identify potentially deceptive statements in or during a corporate disclosure, such as an earnings calls relating to a corporation's financial position, a written disclosure about a corporation's compliance with securities regulations or other similar disclosures relating to a company's financial, corporate or legal position.

Recent months have seen an upheaval in corporate governance and the scrutiny of disclosures by corporate officers relating to the financial health of their companies, their company's compliance with securities regulations and other matters. Investors and securities regulators are increasingly skeptical about disclosures made by such officers in interviews, written disclosures and in their corporate filings. Thus far, investors have not had an accurate and reliable method for assessing the veracity of such disclosures, which have too often turned out to be inaccurate. Investors have either accepted such disclosures on faith or have evaluated them on an ad hoc basis. Neither approach is satisfactory in light of the substantially increased likelihood of loss from an investment decision based on inaccurate or misleading information.

Accordingly, there is a significant need for a reliable and practical method of identifying potentially deceptive disclosures or statements within disclosures by corporate officers relating to the financial position and overall status of their companies.

### SUMMARY

The systems and methods described herein include a method for identifying potentially deceptive statements in a corporate disclosure. Declaration portions or interview portions, or both, of a disclosure given by a corporate representative are reviewed to determine whether a cluster of deceptive behaviors is exhibited in response to stimuli. A declaration is typically, although not always, a series of statements intended to set out a position or viewpoint that the representative would like to make known. During a declaration, a stimulus might be the beginning of the declaration, a change in topics or the beginning of a statement. During an interview, a stimulus will typically be a question posed by an interviewer.

Deceptive behaviors may be verbal or non-verbal. Verbal behaviors are related to language. Non-verbal behaviors are those not related to language, including audible behaviors.

Verbal behaviors that may be identified as deceptive behaviors may include:
(i) failure to respond substantively to a stimulus (i.e. a question) during an interview;
(ii) repeating all or a portion of the question;
(iii) giving an unnecessarily and overly specific answer to a question;
(iv) expressing an inappropriate level of concern for an issue or topic raised by a stimulus;
(v) responding to a stimulus by making verbal attacks directed at the interviewer or another party;
(vi) using qualifying language in response to the stimulus;
(vii) invoking religion or other moral authorities to emphasize the purported integrity of an answer;
(viii) failure to understand simple or well-known terms, concepts or questions;
(ix) using phrases intended to indicate an incomplete or uncertain memory;
(x) being excessively courteous;
(xi) complaining about the subject matter of the stimulus, or the interview in general;
(xii) stating that they are reluctant or unwilling to answer a question;
(xiii) asking inappropriate or out of place questions in response to a stimulus; or
(xiv) responding to the stimulus with a protest, rather than with the responsive, factual information requested.

A protest may be a response (or portion of a response) to a stimulus that is intended to convince a listener of a position taken by the representative rather than to convey information relating to the topic of the stimulus.

Non-verbal behaviors that may be identified as deceptive behaviors include:
(i) pausing or delaying after a question prior to giving an answer;
(ii) movement of anchor points, which are the physical connections where the representative's body touches a support, such as the floor or a chair.
(iii) physical movement backward (while sitting or standing)
(iv) release mechanisms, which include
   1. grooming gestures, such as adjusting clothes, hair, jewelry or eyeglasses, inspecting hands or nails;
   2. cleaning up surroundings, such as straightening up piles of books, picking up lint;
   3. covering mouth or eyes;
   4. wringing hands;
   5. scratching a part of the body;
   6. clearing throat before answering a question;
   7. biting lips; or
   8. wiping sweat.

A cluster of deceptive behaviors may be understood to include, although not be limited to, a group of at least two deceptive behaviors that begins between the beginning of a stimulus and up to about five seconds after the end of the stimulus and then continues uninterrupted. Only one of the behaviors need begin during this time period. All deceptive behaviors that occur continuously, or concurrently, with or after the first deceptive behavior are counted as separate deceptive behaviors. If a cluster of deceptive behaviors is identified, the stimulus associated with the cluster and the subject of the stimulus and the answer (if the cluster occurs during an interview) are noted as containing possibly deceptive statements.

All or any portion of a disclosure may be analyzed to identify potentially deceptive statements by the representative. Typically, a reviewer will review all declarations in a disclosure and all questions in any interview portions of a disclosure to identify potentially deceptive statements by the representative. However, the reviewer may focus on portions of a disclosure. For example, in some embodiments, a reviewer may apply the methodology described herein to those questions and answers in the interview portion of a disclosure that relate to the future performance of the entity that the representative is associated with. In other embodiments, the reviewer may select a subset of the deceptive behaviors and use the selected behaviors to identify clusters of deceptive behaviors in a disclosure.

The methods described herein are typically applied to recordings of disclosures, although they may be applied to live disclosures, whether in person or via some media. Typically, although not necessarily, the reviewer will be a different person than the interviewer. The invention thus provides a mechanism for analysis of an interview that was conducted by a third party, such as a financial reporter for a television news program. The reviewer will typically obtain video, audio and/or written transcripts recording the disclosure and will attempt to identify deceptive behaviors using all the different recordings of the disclosures. However, the systems and methods described herein may be applied even if only one form of recording is available. For example, a video recording typically includes an audio component and may be used to identify both verbal and non-verbal behaviors. An audio recording may be used to identify verbal and some non-verbal behaviors, such as sighing, pausing before answering a question or throat clearing. A transcript may be used to identify most verbal behaviors. A transcript annotated with a description of a representative's physical behavior may also be used to identify non-verbal behaviors.

Other variations, embodiments and aspects of the invention are described below.

### BRIEF DESCRIPTION OF THE DRAWINGS

The invention will now be described, by way of example only, with reference to the drawings, in which:

FIG. 1 is diagram illustrating a disclosure analyzed according to the invention;

FIG. 2 is a flowchart illustrating an exemplary method of analyzing corporate disclosures according to the invention;

FIG. 3 is a flowchart illustrating a method of analyzing a question and answer that are part of an interview portion of a disclosure; and

FIG. 4 depicts one system according to the invention.

### DESCRIPTION OF EXAMPLE EMBODIMENTS

To provide an overall understanding of the invention, certain illustrated embodiments will now be described, including systems and methods for determining whether a corporate disclosure includes a deceptive disclosure or omission. However, it will be understood by those of ordinary skill in the art that the systems and methods described herein may be adapted and modified for other suitable applications and that such other additions and modifications will not depart from the scope hereof.

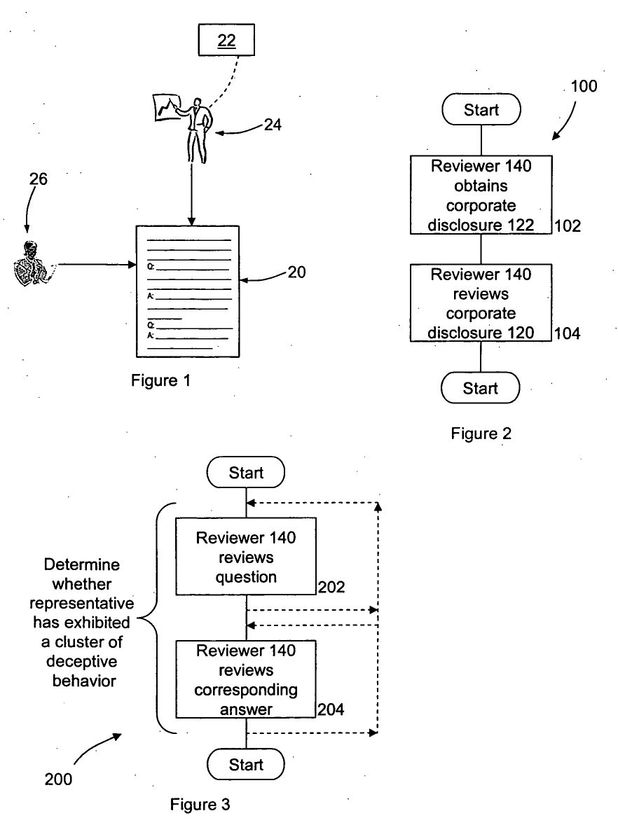

Reference is first made to FIG. 1, which illustrates pictorially a corporate disclosure 20. Disclosure 20 is typically made by a representative 24 of company 22. Corporate disclosure 20 may include a declaration relating to a company 22. Disclosure 20 may also include an interview consisting of a series of questions asked by an interviewer 26 and series of answers given by representative 24.

Typically, representative 24 will be a member of senior management of the company 22, although the disclosures may be made by another person associated with company 22, such as a non-senior employee or an accountant, or other professional advisor who has knowledge of company 22. Typically, representative 24 will have knowledge relating to the subject matter of disclosure 20 that may be of interest to investors, regulators, competitors, and other parties associated with company 22.

Disclosure 20 may also be made by more than one representative 24 of company 22. An interview portion of disclosure 20 may be conducted by more than one interviewer 26. Also, disclosure 20 may relate to more than one company 22. For example, disclosure 20 may relate to two or more related companies (for example, affiliated companies or co-owned companies) or may relate to two unrelated companies that have some association (such as competitors or members of an industry group).

Disclosure 20 may include one or more declarations and one or more interviews. Disclosure 20 may also be included with, and interspersed with, other information relating to company 22, or other information.

The term “statement” is used herein to describe a single sentence, comment, remark, etc. during either a declaration or an interview. Typically, a declaration is a prepared text or speech consisting of one or more statements that the representative has assembled prior to making disclosure 20. A declaration need not be previously prepared. A declaration may be made to set out some information or positions that the representative would like to make known. In other cases, a declaration may simply be some opening or closing remarks during a press conference or as part of an interview. Typically, representative 24 will make a declaration at the beginning and/or end of disclosure 20. However, representative 24 may make a declaration at any point in disclosure 20.

An interview portion of disclosure 20 typically includes a series of questions presented by interviewer 26 and a corresponding series of answers from representative 24. Each answer may include one or more statements.

For example, disclosure 20 may be:
(i) a declaration made by the CEO or other member of senior management (the representative 24) of a company 22;
(ii) an interview given by a member of senior management of a company 22 to an interviewer 26, who may be a securities analyst, an investor, or a reporter for broadcast or print media
(iii) a combination of a declaration by an officer of a company 22 and an interview given by two or more members of senior management 22 to two or more interviewers; or
(iv) an interview given by an officer of a company 22 as part of a group discussion including two or more officers of other companies and may include one or more interviewers.

Disclosure 20 may be a live presentation, observed in person or through some media (for example, broadcast or closed circuit television or radio) or it may be recorded in various forms, or both. For example, disclosure 20 may be recorded in:
(i) video recording, which includes a visual recording of non-verbal components of disclosure and an audio recording of verbal and non-verbal components of the disclosure;
(ii) an audio recording of verbal and non-verbal components disclosure 20;
(iii) a transcript of verbal components of disclosure 20;
(iv) a transcript of verbal components of disclosure 20 that further includes a description of non-verbal behaviors exhibited by the representative 24.

The invention in one aspect is a method of identifying potentially deceptive information in a corporate disclosure through objective analysis based on the existence and identification of certain specific verbal and non-verbal behaviors that occur in response to a stimulus within a specified time frame. A verbal behavior is one associated with language. A non-verbal behavior may relate to any non-language aspect of a person's behavior during a disclosure. Some non-verbal behaviors are audible, such as pauses or clearing of the throat while listening to a question or giving an answer.

In one practice, a reviewer reviews the disclosure to correlate deceptive behavior exhibited by a representative 24 while making or giving disclosure 20 with information being discussed at the time of the deceptive behavior. The method involves the identification of specific deceptive verbal and non-verbal behaviors that occur in response to a stimulus.

During a declaration portion of a disclosure 20, a stimulus may be the beginning of the declaration, the beginning of a statement or a change in topic. During an interview portion of a disclosure, a stimulus will typically be a question asked by the interviewer 26, although it may be a change in topic during an answer given by the representative 24.

One or more of the following example behaviors may be treated as deceptive verbal behaviors by a representative in different embodiments of the invention:
(i) failure to provide a substantive response to a question (that constitutes the stimulus) during an interview;
(ii) repeating all or a portion of the question;
(iii) giving an unnecessarily and overly specific answer to a question;
(iv) expressing an inappropriate level of concern for an issue or topic raised by a stimulus
(v) responding to a stimulus by making verbal attacks directed at the interviewer 26 or another party that has raised a question about the representative 24 or the company 22;
(vi) using qualifying language in response to the stimulus, such as phrases that emphasize the truth of an answer (for example, “To be perfectly honest . . . ”, “in truth, . . . ”) and phrases that indicate that the answer is simplified or lacking in detail (for example, “Frankly, . . . ”, “Basically, . . . ”);
(vii) invoking religion or other moral authorities to emphasize the purported integrity of an answer;
(viii) failure to understand simple or well-known terms, concepts or questions;
(ix) using phrases intended to indicate an incomplete or uncertain memory such as “To the best of my knowledge . . . ” or “Not that I can remember . . . ”;
(x) being excessively courteous (for example, using Sir or Madam in response to the stimulus);
(xi) complaining about the subject matter of the stimulus, or the interview in general (“Why is everyone always asking me that? Or “How long is this going to take, I have a plane to catch”
(xii) stating that they are reluctant or unwilling to answer the question;
(xiii) asking inappropriate or out of place questions in response to a stimulus; or
(xiv) responding to the stimulus with a protest, rather than with the responsive, factual information requested. According to the invention, a protest is a response (or portion of a response) to a stimulus that is intended to convince a listener of a position taken by the representative rather than to convey information relating to the topic of the stimulus. Protests include:
   1. A response or portion of a response relating to the reputation or status of the representative 24 or the company 22 that is designed to place the company or executive in a positive light (i.e., “We've been in business for 50 years,” “Our reputation is above reproach:”) instead of providing a factual and direct response to the stimulus.
   2. In response to a stimulus, referencing specific information, appeals or references to external authority, such as corporate regulators or accounting standards designed by implication to position the company in a positive light (“We do everything according to GAAP;” “We have a long and positive history with the SEC.”)

One or more of the following behaviors are treated by a reviewer as deceptive non-verbal behaviors by a representative:
(i) pausing or delaying after a question prior to giving an answer;
(ii) movement of anchor points, which are the physical connections where the representative's body touches a support, such as the floor or a chair. For example, when standing with her hands in her pockets, a person's anchor points are her feet touching the floor and her hands in her pockets; when sitting in a chair at a table, a person's anchor points are his back against the chair, his feet on the floor, his buttocks on the seat and his arms on the table (if they are indeed on the table).
(iii) physical backward movement (while sitting or standing)
(iv) release mechanisms, which include
   1. grooming gestures such as adjusting clothes, hair, jewelry or eyeglasses, inspecting hands or nails;
   2. cleaning up surroundings, such as straightening up piles of books, picking up lint;
   3. covering mouth or eyes;
   4. wringing hands;
   5. scratching a part of the body;
   6. clearing throat before answering a question;
   7. biting lips; or
   8. wiping sweat.

According to the invention, the presence of a cluster of deceptive behaviors beginning during the period defined by the start of a stimulus and ending 5 seconds after the end of the stimulus is indicative of a potentially deceptive statement during disclosure 20. A cluster of deceptive behaviors is a group of any combination of two or more deceptive behaviors. A cluster may include two verbal or non-verbal deceptive behaviors or one verbal and one nonverbal deceptive behavior. The first deceptive behavior in the cluster need only begin during this time period. All deceptive behaviors that occur continuously with the first deceptive behavior are identified and counted as separate deceptive behaviors in the cluster. In addition, deceptive behaviors that occur simultaneously during the first or subsequent continuous deceptive behaviors are counted separately. For example, a cluster may consist of two simultaneous deceptive behaviors. The greater the number of deceptive behaviors in a cluster, the higher the likelihood that the representative has made a deceptive statement. The deceptive statement may itself be the stimulus for the deceptive behaviors (typically during a statement) or may be in response to a stimulus (typically a question during an interview).

In other embodiments, a shorter time period may be used to determine the beginning of the first deceptive behavior in a cluster of deceptive behaviors. For example, in another embodiment, the first deceptive behavior may be required to begin during the time period defined by the beginning of a stimulus and ending 3 seconds after the end of the stimulus.

In other embodiments, a longer time period may be used to determine the beginning of the first deceptive behavior in a cluster of deceptive behaviors. In such an embodiment, a first deceptive behavior that begins more than 5 seconds after the end of a stimulus, but before the expiry of the selected time period, may be the first deceptive behavior in a cluster of deceptive behaviors.

Reference is next made to FIG. 2, which illustrates a method 100 according to a first embodiment of the invention. Method 100 begins in step 102, in which a reviewer 140 obtains a corporate disclosure 120. In this exemplary embodiment of the invention, reviewer 140 obtains two recordings of disclosure 120: a video recording 130 and a transcript 132 of the disclosure 122. Method 100 next proceeds to step 104.

In step 104, reviewer 140 reviews video recording 130 and transcript 132. Reviewer 140 may review video recording 140 and transcript 132 simultaneously, separately or in any order or combination. For example, reviewer 140 may review all of video recording 130 followed by transcript 132, or vice versa. Reviewer 140 may review parts of video recording 130 and transcript 132 alternately. Reviewer 130 may review all of part of video recording 130 or transcript 132 any number of times and in any order at any point during method 100.

While reviewing video recording 130 and transcript 132, reviewer 140 attempts to identify clusters of verbal and/or non-verbal deceptive behaviors. Non-verbal deceptive behaviors may be observed by watching video recording 130. Verbal deceptive behaviors may be observed by listening to the audio component of video recording 130 or by reading transcript 132. In addition, some non-verbal behaviors, such as throat clearing or pausing may be observed by listening to the audio component of video recording 130. Some non-verbal behaviors may also be observed by reviewing a transcript, for example, where the representative 124 indicates that he is pausing, or where the transcript is annotated to indicate the representative's non-verbal behavior.

Disclosure 120 may contain one or more declarations by representative 122, as was described above in relation to disclosure 20. If reviewer 126 identifies any clusters of deceptive behavior that occur during or within 5 seconds of a stimulus during a declaration, then reviewer 126 notes the statement or statements comprising the stimulus associated with the cluster. The statement or statements are identified as being potentially deceptive.

Disclosure 120 may contain one or more interview portions comprising a series of questions posed by an interviewer 126 and answers given by representative 124. Reviewer 140 analyzes the representative's verbal and non-verbal behaviors in response to all or a portion of the questions in accordance with method 200.

Reference is next made to FIG. 3, which illustrates a method 200 for evaluating the representative's responses to a question, including the representative's verbal answer. Method 200 begins in step 202 in which reviewer 140 reviews the question to determine the subject matter of the question and information requested from the representative 124. This is typically done by listening to the audio component of the video recording 130 and reading the corresponding portion of the transcript 132.

Method 200 next proceeds to step 204 in which reviewer 140 reviews the representative's answer. This is typically done by listening to the audio component of the video recording 130 and reading the corresponding portion of the transcript 132.

Either or both of steps 202 and 204 may be repeated any number of times to allow reviewer 140 to review the question and answer. These steps may be repeated during or between any of the steps of method 200.

During steps 202 and 204, reviewer 140 determines whether the representative 124 has exhibited a cluster of deceptive behavior.

For example, if the representative does not begin providing the information requested in the question within 5 seconds from the end of the question, then reviewer 140 notes this as one deceptive behavior (failing to answer the question). For each protest statement made by the representative, the reviewer notes it as a deceptive behavior. As a result a cluster of deceptive behavior exists if in response to a question, the representative simply responds with an uninterrupted series of protest statements. For example, if the interviewer 126 asks “Your company has been accused of overstating its earnings last quarter. What were you earnings?” the representative may respond with a protest such as “My company's reputation is impeccable. We would not mislead our investors.” In this case, a cluster of three deceptive behaviors has occurred: a failure to answer the question by providing the information requested and two protest statements aimed to convince a listener that the company is honest. A non-deceptive answer would convey responsive information: a specific amount of earnings.

If a cluster of two deceptive behaviors is identified, then reviewer 140 notes the question and the subject matter of the question and the answer and identifies the answer as being potentially deceptive.

Reviewer 140 may also note each question for which a cluster of deceptive behavior was not identified.

Method 200 is repeated for at least some of the questions and corresponding answers in the interview portion or portions of disclosure 120. Typically, reviewer 140 will repeat method 200 for all of the questions and corresponding answers in disclosure 120.

When reviewer 140 has completed the analysis of disclosure 120, method 100 ends. The product of method 100 are the notes made by reviewer 124. These notes identify the subject matter of stimuli in any declaration portions of disclosure and the subject matter of answers in interview portions 120 that were identified as being potentially deceptive.

These notes may be used as a basis for further investigation or analysis of disclosure 120. Notes from different disclosures by representative 124 relating to similar or different topics may be used to identify consistent deceptive behavior and deceptive information.

Many different embodiments and practices of the invention are possible. Some additional exemplary embodiments are described here, utilizing the reference numerals set out above in relations to the first embodiment.

In a second exemplary embodiment, a reviewer may identify clusters of deceptive behavior only during interview portions of disclosure 120. Reviewer 140 may review any declaration portions of disclosure 120, but may do so for the purpose of understanding the issues discussed in disclosure 120.

In a third exemplary embodiment, a reviewer 140 may identify only some of the behavior listed above as deceptive behaviors. For example, reviewer 140 may identify only the following as non-verbal deceptive behaviors: pausing after a question before giving an answer; shifting anchor points and exhibiting release mechanisms and may identify only the following as verbal deceptive behaviors: repeating a stimulus question, refusing to answer a question, verbally attacking the interviewer 126, invoking religion, qualifying an answer and exhibiting selective memory.

In another embodiment of the present invention, reviewer 140 may review only some of the questions and answers in interview portions of disclosure 120 to identify clusters of deceptive behavior. For example, the reviewer may review only those exchanges relating to specific topics of interest to the reviewer. For example, reviewer 140 may review only questions and answers that cover subject matter related to the future performance relating to revenue growth, earnings, merger and acquisition activity and other future-oriented subject matter. Alternatively, a reviewer may review other questions, including questions that relate to past or current information, but may identify clusters of deceptive behavior that occur in association with a future-oriented subject matter as being of particular importance for future review.

In another embodiment, reviewer 140 may identify (or be provided with) a specific type or types of information that is of particular interest. Reviewer 140 may then identify only clusters of deceptive behavior that occur in association with questions and answers that relate to those specific types of information. For example, a reviewer may focus on questions and answers (and portions of declarations) relating to accounting systems, problems and irregularities, adherence to SEC regulations and/or corporate governance.

In other embodiments, reviewer 140 may have access to only an audio recording of a disclosure or a transcript of the disclosure. In such cases, reviewer 140 may be able to identify only verbal deceptive behaviors. A cluster of deceptive behavior would comprise two or more such verbal behaviors.

If reviewer 140 has access to a transcript that is annotated with the physical behavior of representative 124, then reviewer 140 may be able to identify some non-verbal deceptive behaviors.

In another embodiment, reviewer 140 may restrict his or her analysis to portions of a disclosure 120 that relate to one or more selected topics. For example, reviewer 140 may determine prior to reviewing disclosure 120 that he or she will evaluate only questions relating to the corporate governance of company 122. While reviewing disclosure 120, reviewer 140 does not analyze any parts of any declarations or interview portions that do not relate to the selected topics. Reviewer 140 may review these portions, but methods 100 and 200 are applied only to those portions of the disclosure that do relate to selected topics.

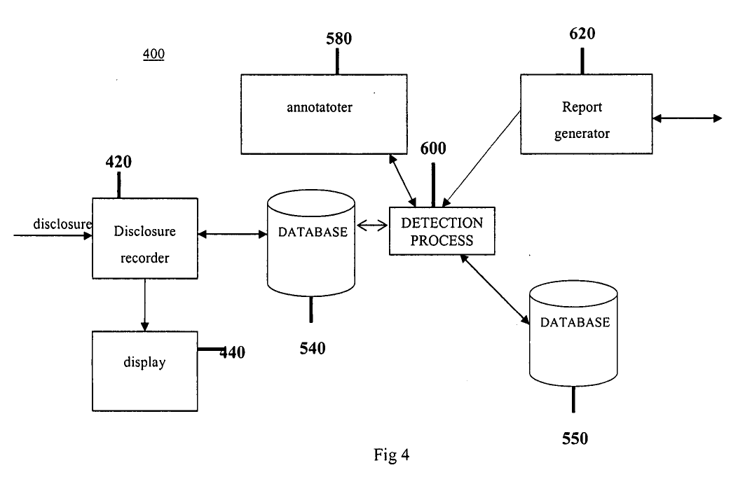

FIG. 4 depicts a first system according to the invention. Specifically FIG. 4 depicts a system 400 that includes a disclosure recorder 420, a display system of 440, a first database 540 that has storage for a recording of the disclosure, and a second database of 550 that has storage for a set of predetermined stimulus and deceptive behaviors. The system 400 further includes a detection process 600, and annotator 580, and a report generator 620.

As shown by FIG. 4 the disclosure made by the corporate representative may be recorded by the disclosure recorder 420. The disclosure recorder 420 can be any suitable device of the type capable of recording either audio, video, or both. Additionally, in other embodiments the disclosure recorder 420 includes sensors that record other characteristics of the representative, such as physiological characteristics including heart rate, temperature or other physiological. As further shown in FIG. 4, once the disclosure is recorded a database 540 can store a record of the disclosure. At a later time, a reviewer can activate the display 440 that can be an audio-visual display which is capable of replaying to the reviewer the record stored in database 540.

In the embodiment depicted FIG. 4 a detection process 600 is provided. The optional detection process 600 may be a software process operating on a conventional computer system that is capable of reviewing the record stored in database 540 and determining the occurrence of possible deceptive behavior within the recorded disclosure. To this end, the detection process 600 may include a software process capable of analyzing the speech or text of a corporate disclosure and identifying within the speech or text certain trigger words that are indicative of deceptive behavior. In further optional embodiments, the detection process 600 may include a video processor that is capable of analyzing video data stored as part of the record. The video data may be analyzed to determine suspected indicia of deceptive behavior, such as sudden physical movements of the representative.

FIG. 4 further depicts the annotator 580. Through the annotator 580 the reviewer monitoring the display 440 can manually cause the detection process 600 to annotate the record stored in database 540 to include notes indicating the occurrence or presence of suspected, deceptive behavior within the record of a corporate disclosure. In the embodiment depicted in FIG. 4, the system 400 includes a database 550 that can include a list of different types of deceptive behavior which the reviewer may reference when annotating.

Upon completion of annotating the record, a report generator module 620 may be activated which can produce a report indicating the likelihood of deceptive behavior having occurred during the corporate disclosure and where this deceptive behavior occurs within that disclosure.

As discussed above, the system 400 may be realized as a software component operating on a conventional data processing system such as a Unix workstation. In that embodiment, the system 400 may be implemented as a C language computer program, or a computer program written in any high level language including C++, Fortran, Java or Basic. General techniques for such high level programming are known, and set forth in, for example, Stephen G. Kochan, Programming in C, Hayden Publishing (1983).

The depicted databases can be any suitable database system, including the commercially available Microsoft Access database, and can be a local or distributed database system. The design and development of suitable database systems are described in McGovern et al., A Guide To Sybase and SQL Server, Addison-Wesley (1993). The database can be supported by any suitable persistent data memory, such as a hard disk drive, RAID system, tape drive system, floppy diskette, or any other suitable system. Moreover, although FIG. 4 graphically depicts the system 400 as comprising a set of functional block elements, it will be apparent to one of ordinary skill in the art that these elements can be realized as computer programs or portions of computer programs that are capable of running on a data processor platform to thereby configure the data processor as a system according to the invention.

The systems and methods described herein are capable of additional variations and modifications without departing from the description set out here. All such variants fall within the scope of the invention.

1. A method for analyzing a corporate disclosure, comprising
providing a record of a disclosure made by a representative,
identifying a stimulus given to the representative,
reviewing for a pre-determined period of time behavior of the representative responsive to the stimulus to determine the presence of a cluster of deceptive behaviors, and
noting an identified cluster within a record of the disclosure.

2. A method according to claim 1, wherein identifying a stimulus includes identifying a question posed to the representative.

3. A method according to claim 1, wherein reviewing behavior includes reviewing behavior for a predetermined verbal or non-verbal response.

4. A method according to claim 1, further comprising subdividing the disclosure into sections.

5. A method according to claim 4, wherein subdividing into sections includes topics, time periods, representatives, and interviewers.

6. A system for analyzing a corporate disclosure, comprising
a recorder for generating a record of a disclosure by a corporate representative,
a display for presenting the record for analysis by a reviewer, and
annotation means for allowing the reviewer to annotate the record to indicate the presence of a cluster of deceptive behavior delivered in response to a stimulus and within a predetermined time period.
